(19) United States
(12) Patent Application Publication
(10) Pub. No.: US 2024/0187327 A1
(43) Pub. Date: Jun. 6, 2024

(54) MODULE AND METHOD FOR MANAGING A FUNCTIONAL PROCESS, AND ASSOCIATED COMPUTER PROGRAM AND COMPUTER NETWORK

(71) Applicant: FONDATION B-COM, CESSON SEVIGNE (FR)

(72) Inventors: Michel TREFCON, SAINT-SULPICE LA FORET (FR); Philippe BERTIN, ACIGNE (FR)

(21) Appl. No.: 18/556,452

(22) PCT Filed: Apr. 14, 2022
(86) PCT No.: PCT/EP2022/060082

§ 371 Date: Oct. 20, 2023

(30) Foreign Application Priority Data
Apr. 23, 2021 (FR) FR2104237

(51) Int. Cl. H04L 43/103; H04L 43/0817

(52) U.S. Cl. CPC H04L 43/103; H04L 43/0817

(57) ABSTRACT

A management module (NRF), management method, and an associated computer network and computer program configured to manage at least one functional process (NF1; NF2; NF3; NF4) of a computer network (CN) are designed to check the arrival of a heartbeat message from the functional process within a time window of a duration stored by the management module (NRF). The management module (NRF) is designed to determine the duration.

### TECHNICAL FIELD OF THE INVENTION

The present invention relates to a module and a method for managing a functional process, and associated computer program and computer network.

### STATE OF THE ART

In a computer network, a management module can be used in particular to monitor the activity of other functional processes implemented in the network.

Such a management module can then be designed to check, for each functional process, the arrival of a heartbeat message from this functional process within a time window of predetermined duration. The management module thus makes sure of the continuity of activity of the functional process and, in the absence of receipt of the heartbeat message within the above-mentioned time window, can for example signal the absence of activity of the functional process to the other functional processes.

According to the technical specification 3GPP TS 29.510 V15.2.0 for example, a management unit called NRF (for “Network Function Repository Function”) checks, for each “Network Function” (or NF) previously registered with this management unit, the arrival of a heartbeat message from this network function (NF) within a time window whose duration is either a duration required by the network function, or a preconfigured duration imposed by the management unit.

### DISCLOSURE OF THE INVENTION

In this context, the present invention proposes a management module for managing at least one functional process of a computer network, the management module being designed to check the arrival of a heartbeat message from the functional process within a time window of duration stored by the management module, characterized in that the management module is designed to determine said duration.

The time window duration is thus not configured once and for all, but can be adapted in real time to system operation.

The functional process can be implemented by a processor fitted for example on an electronic unit (or node) of the computer network. The functional process is for example implemented due to the execution, by this processor, of computer program instructions (which may be stored in a memory of the electronic unit, or node, of the computer network).

The management module can be designed to determine said duration upon receipt of a preceding heartbeat message from the functional process.

The management module can for example be designed to determine said duration upon each receipt of a heartbeat message from the functional process. The time window duration can thus possibly be updated on a regular basis.

The management module can moreover be designed to determine said duration upon receipt of a registration request from the functional process.

The management module can further be designed to send the determined duration to the functional process. That is the case in particular when the time window duration is determined upon receipt of a preceding heartbeat message; the functional process is thus informed about the (possible) update of the time window duration.

The management module can be designed to determine said duration as a function of data related to the functional process, and/or as a function of data related to another functional process distinct from the functional process.

According to another possibility, which may possibly be combined with the preceding one, the management module is designed to determine said duration as a function of at least one estimated time of receipt of a heartbeat message from another functional process distinct from the functional process. In practice, this estimated time can correspond to (or be determined based on) the time window duration (previously) assigned (by the management mode) to this other functional process. Indeed, this time window duration previously assigned to another functional process is stored in the memory of the management module.

The management module can moreover be designed to modify, when the heartbeat message is not received within said time window, a status of the functional process stored in the management module.

In practice, the heartbeat message can be a request for updating a profile of the functional process stored in the management module.

The invention also proposes a computer network comprising a management module as proposed hereinabove and a processor configured to implement the functional process. Such a computer network can be a telecommunication network or be part of a telecommunication network.

Correlatively, the invention proposes a method for managing at least one functional process of a computer network, comprising the following steps:
determining a time window duration;
checking the arrival of a heartbeat message from the functional process within a time window having the determined duration.

The optional features presented hereinabove relating to the management module can also be applied to this management method.

The invention also proposes a computer program comprising instructions executable by a processor and designed to implement a management method as mentioned hereinabove when these instructions are executed by the processor.

The invention finally proposes a recording medium, possibly removable, readable by such a processor and storing such a computer program.

Of course, the different features, alternatives and embodiments of the invention can be associated with each other according to various combinations, insofar as they are not mutually incompatible or exclusive.

### DETAILED DESCRIPTION OF THE INVENTION

Moreover, various other features of the invention will be apparent from the appended description made with reference to the drawings that illustrate non-limiting embodiments of the invention, and wherein:

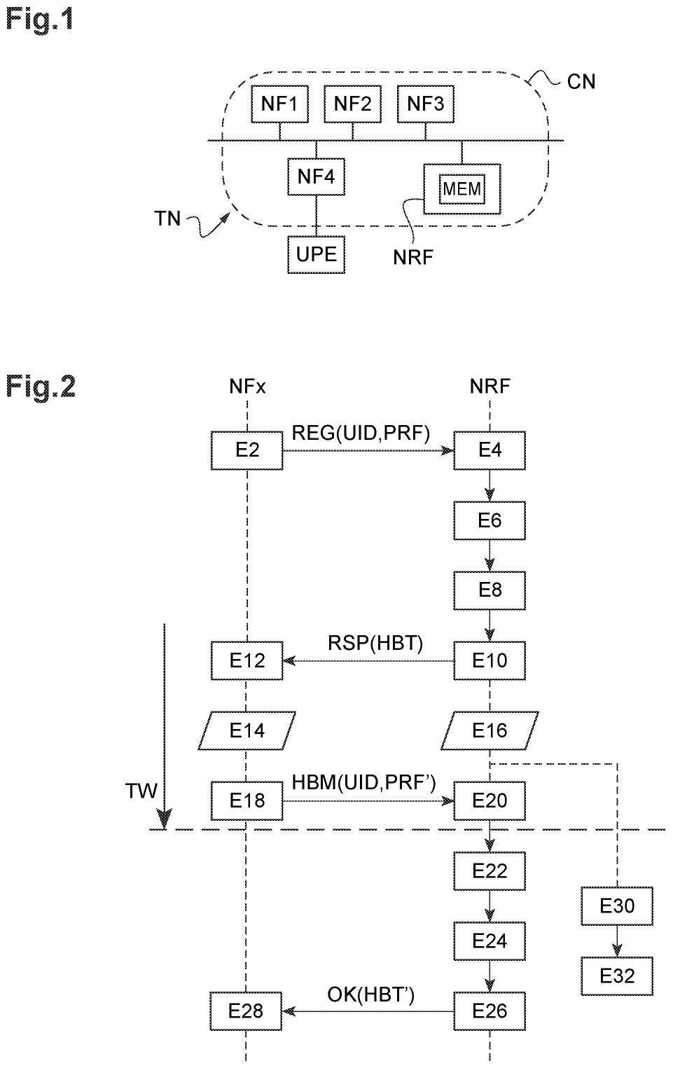

FIG. 1 shows a telecommunication network comprising a computer network according to the invention;

FIG. 2 is a flowchart showing the possible operation of a functional process and a management module of this computer network, and exchanges between these two elements;

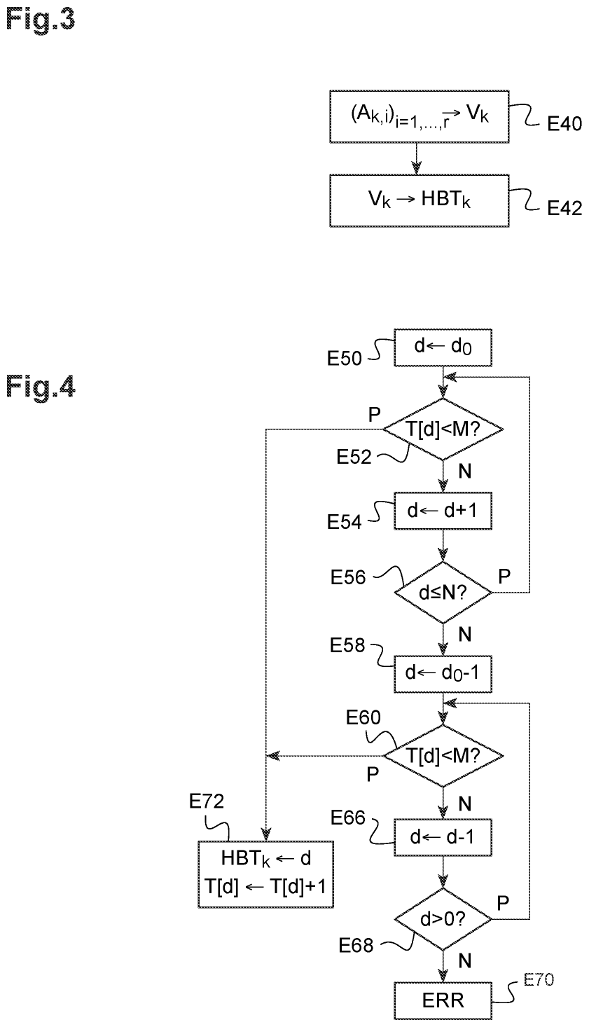

FIG. 3 is a flowchart showing the main steps of a conceivable method for determining a time window duration; and

FIG. 4 is a flowchart showing another conceivable method for determining a time window duration.

FIG. 1 shows a telecommunication network TN comprising a computer network CN according to the invention.

The telecommunication network TN also comprises by way of illustration a user equipment UPE (or “User Plane Equipment” in the terminology sometimes used). In practice, naturally, the telecommunication network TN can comprise other user equipments.

In the example described herein, the computer network CN is a core network of the telecommunication network TN, as defined for example in the technical specification 3GPP TS 23.501 V15.11.0.

The computer network CN comprises a management module NRF and a plurality of nodes each implementing a functional process NF1, NF2, NF3, NF4. The management module NRF can itself form one node of the computer network CN.

Each node of the computer network CN is for example made in practice by an electronic unit forming the management module NRF or designed to implement at least one functional process NF1, NF2, NF3, NF4, and connected to the other electronic units by a connection (for example, a wire connection) for data exchanges between the different functional processes NF1, NF2, NF3, NF4 (between each other) and between the different functional processes NF1, NF2, NF3, NF4 and the management module NRF.

For the sake of clarity, each functional process NF1, NF2, NF3, NF4 and the management module NRF have been represented on one node of the computer network CN. However, in practice, a same node of the network or a same electronic unit could implement several functional processes NF1, NF2, NF3, NF4 and/or form the management module NRF.

Each functional process NF1, NF2, NF3, NF4 is for example implemented due to the execution, by a processor of the electronic unit (or network node) concerned, of computer program instructions stored in (a memory of) this electronic unit (or this network node). Likewise, the operation of the management module NRF (in particular as described hereinafter) can also be obtained by execution, by a processor of an electronic unit (or network node), of computer program instructions stored in this electronic unit (or this network node), precisely in a memory MEM of this electronic unit (or this network node). For the sake of brevity, this memory MEM of the electronic unit implementing the management module NRF will be considered as the “management module memory”.

As will become apparent in the following, the management module NRF is designed with the following functionalities: registration for listing the functional processes NF1, NF2, NF3, NF4, monitoring activity of each of the registered functional processes NF1, NF2, NF3, NF4 and communicating information related to a functional process to the other functional processes NF1, NF2, NF3, NF4.

The management module NRF plays for example the role of “Network Function Repository Function” according to the technical specification 3GPP TS 23.501 V15.11.0.

The functional processes NF1, NF2, NF3, NF4 are each designed with specific functionalities, here linked to the operation of the telecommunication network NT. Each of the functional processes NF1, NF2, NF3, NF4 is for example one of the following functional processes:
“Access and Mobility Management Function” (or AMF);
“Session Management Function” (or SMF);
“Authentication Server Function” (or AUSF);
“Unified Data Management” (or UDM);
“Policy Control Function” (or PCF).

Therefore, in the example described herein, the functional processes NF1, NF2, NF3, NF4 and the management module NRF belong to the “control plane” of the telecommunication network TN.

Some functional processes NF4 are moreover connected to one or several user plane equipments UPEs (or more simply one or several user equipments), for example by means of a wired or wireless link (or by means of a combination of wired and wireless links). (A single such functional process NF4 is shown in FIG. 1 by way of simplification).

FIG. 2 is a flowchart showing the possible operation of a functional process NFx and the management module NRF, and exchanges between these two elements.

The functional process NFx can be any one of the functional processes NF1, NF2, NF3, NF4 mentioned hereinabove.

The method of FIG. 2 starts with a step E2 in which the functional process NFx sends a request REG for registration with the management module NRF.

This registration request REG here comprises an identifier UID (for example, a unique identifier) of the functional process NFx and the current profile PRF of the functional process NFx. This registration request REG is for example obtained in practice by a “PUT request” sent by the functional process NFx to the management module NRF.

The current profile PRF contains for example the following attributes (related to the functional process NFx):
a priority attribute of the functional process NFx;
a capacity attribute of the functional process NFx;
a load attribute of the functional process NFx;
a type attribute of the functional process NFx;
a list of mobile telecommunication networks that use the functional process NFx;
one or several identifier(s) of a “network slice” or a network slice instance;
a list of identifiers of network slice instances to which the functional process NFx belong;
a status attribute of the functional process NFx;
an attribute indicating the time instant (date and/or time) at which the functional process NFx starts (or the duration elapsed from this start);
attributes indicating use permissions such as, for example: a list of the allowed public mobile telecommunication networks allowedPlmns, a list of the allowed network function types allowedNfTypes, a list of the allowed network function domains allowedNfDomains, information to assist in the selection of the allowed network slices allowedNssais.

The management module NRF receives the registration request REG (step E4) and registers the current profile PRF in the memory MEM of the management module NRF (step E6). Moreover, the management module NRF can store in the memory MEM of the management module NRF a history of at least some of the above-mentioned attributes, for example a history of the status attribute of the functional process NFx (which enables statistical evaluation of reliability of the functional process NFx, such statistical evaluation being potentially usable for determining the time window duration as described hereinabove).

The functional process NFx can then be discovered by another functional process NF1; NF2; NF3; NF4, that is to say that, by consulting the management module NRF, another functional process NF1; NF2; NF3; NF4 can have access to the current profile PRF of the functional process NFx and/or address to the functional process NFx.

The management module NRF can also store in its memory MEM status information of the functional process NFx indicating that this functional process NFx is registered and/or operational and/or can be discovered by the other functional processes NF1, NF2, NF3, NF4. This status information is for example the “REGISTERED” information.

The management module NRF then performs a step E8 of determining a time window duration HBT. As explained hereinafter, this duration HBT will be used as the time window duration during which the management module NRF expects to receive a heartbeat message HBM from the functional process NFx. In other words, this duration HBT is the maximum duration between two heartbeat messages HBM, beyond which the management module NRF considers that the functional process NFx is no longer active, as explained hereinafter.

The time window duration HBT can be determined (for example, calculated) as a function of data related to the functional process NFx (extracted for example from the current profile PRF of the functional process NFx stored in the memory MEM of the management module NRF) and/or as a function of data related to another functional process NF1; NF2; NF3; NF4 (extracted for example from the profile of this other functional process stored in the memory MEM of the management module NRF) and/or as a function of estimated times of receipt of a heartbeat message from other functional processes NF1; NF2; NF3; NF4 respectively (i.e. for example, in practice, as a function of time window durations previously assigned to the other functional processes NF1, NF2, NF3, NF4).

The time window duration HBT can also be determined in practice as a function of the occurrence of the functional process NFx in the notifications sent to the other functional processes NF1, NF2, NF3, NF4, these latter having subscribed to receive notifications.

Conceivable examples for determining the time window duration HBT are described hereinafter with reference to FIGS. 3 and 4.

The management module NRF stores the so-determined time window duration HBT in its memory MEM.

The management module NRF then sends at step E10 a response RSP to the registration request REG (for example, in practice, a “PUT response”).

The case in which the registration of the functional process NFx with the management module NRF has been achieved successfully will now be described.

In this case, the response RSP indicates the creation of a resource (by containing for example a state code of the type “201 Created”) and contains the created resource and an identifier of the resource (for example, a “Uniform Resource Identifier”, or URI).

The response RSP also contains the time window duration HBT determined at step E8.

The functional process NFx receives the response RSP at step E12 and therefore, in the case described, the time window duration HBT determined at step E8.

The functional process NFx can thus program a mechanism of sending a heartbeat message to the management module NRF within the time window TW of duration HBT.

The operation then continues both at the functional process NFx (step E14) and the management module NRF (step E16) with operations having no relation with the invention and that will therefore not be described herein.

During step E16, in parallel to the above-mentioned operations, the management module NRF is waiting for a heartbeat message from the functional process NFx in order to check the arrival of this heartbeat message in the time window TW defined by the duration HBT determined at step E8 and stored in the memory MEM of the management module NRF.

In normal operation, before expiry of the time window TW defined by the duration HBT, the functional process NFx sends a heartbeat message HBM to the management module NRF (step E18).

This heartbeat message HBM is here a message for updating the profile of the functional process NFx stored (here in the memory MEM) within the management module NRF.

The heartbeat message HBM contains for example in this case the (new) current profile PRF′ of the functional process NFx.

The heartbeat message HBM can moreover contain the identifier UID of the functional process NFx.

The heartbeat message HBM is for example achieved in practice by a “PATCH request” sent by the functional process NFx to the management module NRF. In this case, the identifier UID of the functional process NFx can be present in the request URI.

The management module NRF thus receives the heartbeat message HBM at step E20, before expiry of the time window TW.

The new profile PRF′ (contained in the heartbeat message HBM as indicated hereinabove) can therefore be stored in the memory MEM of the management module NRF (step E22).

The management module NRF then performs a step E24 of determining a (new) time window duration HBT′.

As in step E8, the new time window duration HBT′ can be determined (for example, calculated) as a function of data related to the functional process NFx (extracted for example from the current profile PRF′ of the functional process NFx stored in the memory MEM of the management module NRF) and/or as a function of data related to another functional process NF1; NF2; NF3; NF4 (extracted for example from the current profile of this other functional process stored in the memory MEM of the management module NRF) and/or as a function of estimated times of receipt of a heartbeat message from other functional processes NF1; NF2; NF3; NF4 respectively (i.e. for example, in practice, as a function of time window durations previously assigned to the other functional processes NF1, NF2, NF3, NF4).

The new time window duration HBT′ can also be determined in practice as a function of the occurrence of the functional process NFx in the notifications sent to the other functional processes NF1, NF2, NF3, NF4, these latter having subscribed to receive notifications.

The management module NRF stores the new time window duration HBT′ determined in its memory MEM (for example, in place of the duration HBT).

The elements based on which the time window duration HBT′ is determined may have changed since step E8 and the new duration HBT′ thus takes account of the network conditions in real time.

As indicated for the time window duration HBT determined when the functional process NFx is registered with the management module NRF, conceivable examples for determining the new time window duration HBT′ are described hereafter with reference to FIGS. 3 and 4.

The management module NRF sends at step E26 a response OK to the heartbeat message HBM (for example, in practice, a “PATCH response”).

The case in which the heartbeat message HBM is a message for updating the profile of the functional process NFx within the management module NRF (as already indicated) and the updating has been achieved successfully will now be described.

In this case, the response RSP confirms the modification of the resource (by containing for example a state code of the type “200 OK”) and contains a representation of the modified resource.

The response OK also contains the (new) time window duration HBT′ determined at step E24.

The functional process NFx receives the response OK from the management module NRF at step E28.

In the described case in which the updating is achieved successfully, the response OK contains the new time window duration HBT′ determined at step E24.

The functional process NFx can thus program a mechanism of sending a heartbeat message to the management module NRF within a new time window of duration HBT′.

The operation within the management module NRF thus loops to step E16 for implementing operations having no relation with the invention (and therefore not described herein) and waiting for the next heartbeat message from the functional process NFx.

When no heartbeat message has arrived to the management module NRF from the functional process NFx at expiry of the time window of current duration HBT, HBT′, the management module NRF detects this absence of arrival of the heartbeat message within the time window of current duration HBT, HBT′ and modifies the status information of the functional process NFx stored in the memory MEM (step E30) in such a way that this status indicates this fault. The modified status is for example a status (such as the “SUSPENDED” status) indicating that the functional process NFX is no longer operational and/or can no longer be discovered by the other functional processes NF1, NF2, NF3, NF4.

The management module NRF can then possibly send, to some functional processes (for example to the functional processes previously registered to receive notifications related to the functional process NFx), a message indicating this status change (step E32).

FIG. 3 is a flowchart showing the main steps of a conceivable method for determining a time window duration. This method can be implemented during step E8 described hereinabove or during step E24 described hereinabove.

A_{k,1}, . . . , A_{k,i}, . . . , A_{k,n} here denote n attributes related to a functional process NFk registered within the management module NRF. These n attributes are thus stored (in the profile related to this functional process NFk) in the memory MEM of the management module NRF. These attributes are chosen among the above-mentioned attributes, i.e. for example a priority attribute, a capacity attribute, a load attribute, a type attribute, etc.

The method of FIG. 3 comprises a step E40 of determining an intermediate value (or prevalence value) Vₖ associated with the functional process NFk concerned as a function of one or several attributes A_{k,i} related to the functional process NFk concerned (here as a function of the n attributes A_{k,1}, . . . , A_{k,i}, . . . , A_{k,n} mentioned hereinabove).

In the example described herein, the intermediate value Vₖ is determined by the following calculation:

$${V}_{k} = {\sum }_{i = 1}^{n} {C}_{i} \cdot {F}_{i} ( {A}_{k , i} )$$

where Fᵢ is a function and Cᵢ a weight associated with the attribute A_{k,i} (these function Fi and weight Ci being used for the attribute of index i whatever the functional process NFk concerned).

For each attribute (of index i), the function Fi and the weight Ci are defined according to the attribute nature and to the aspects to be taken into account when implementing the system.

In the example described herein, it is proposed that the intermediate value Vₖ decreases as a function of the relative importance of the functional process NFk associated with this intermediate value Vₖ. In other words, a low intermediate value Vₖ indicates an associated functional process NFk that is important in the system.

It could however be provided as an alternative that a high intermediate value Vₖ indicates an associated functional process NFk that is important for the system.

In the example described herein (low intermediate value Vₖ to indicate a functional process NFk that is important in the system), the function Fᵢ is thus chosen decreasing if it is desired to pay special attention to the functional processes NFk having a high attribute A_{k,i}; on the other hand, the function Fᵢ is chosen increasing if it is desired to pay special attention to the functional processes NFk having a low attribute A_{k,i}.

For example, if it is desired to pay special attention to the functional processes NFk having a high capacity attribute A_{k,c}, the function F_{c} associated with the capacity attributes A_{k,c} is chosen decreasing.

According to another example, when a low priority attribute A_{k,p} (close to 0) characterizes a priority functional process NFk, the function Fp associated with the priority attributes is chosen increasing.

The method of FIG. 3 then comprises a step E42 of determining the time window duration HBTₖ related to the functional process NFk as a function of the intermediate value Vₖ associated with this functional process NFk.

According to a first possible embodiment, the time window duration HBTk related to the functional process NFk is determined (for example calculated) as a function only of the intermediate value Vₖ associated with this functional process NFk (i.e. without taking account of the intermediate values V_{k′} associated with the other functional processes, determined in parallel within the management module NRF).

The time window duration HBTₖ for the functional process NFk is for example calculated proportional to the intermediate value Vₖ. In other words, the time window duration HBTₖ for the functional process NFk is in this case calculated by multiplication of the intermediate value Vₖ by a coefficient of predetermined value.

According to a second possible embodiment, the time window duration HBTk related to the functional process NFk is determined (for example calculated) as a function of the intermediate value Vₖ associated with this functional process NFk and with other intermediate values Vⱼ associated, respectively, with other functional processes NFj than the functional process NFk (and stored in the memory MEM of the management module NRF).

These other functional processes NFj are also registered with the management module NRF and, in the present embodiment, the management module NRF has thus determined, for each other functional process NFj, the intermediate value Vⱼ associated with this other functional process NFj during execution of step E8 (or during the last execution of step E24) when the method of FIG. 1 is implemented for this other functional process NFj.

The management module NRF selects for example the time window duration HBTₖ related to the functional process NFk from a predefined set of possible values in such a way that the functional process ordering by time window duration order corresponds to the functional process ordering by intermediate value order.

The following algorithm can for example be used, in practice:
if no other functional process is registered, the management module NRF sets the time window duration HBTₖ related to the functional process NFk to the smallest possible value;
if the intermediate value Vₖ associated with the functional process NFk is (strictly) lower than all the intermediate values Vⱼ associated, respectively, with the other functional processes NFj (which indicates in the example described herein that the process NFk is more important than the other functional processes NFj), the management module NRF sets the time window duration HBTₖ related to the functional process NFk to the smallest possible value;
if the intermediate value Vₖ associated with the functional process NFk is (strictly) higher than all the intermediate values Vⱼ associated, respectively, to the other functional processes NFj (which indicates in the example described herein that the process NFk is less important than the other functional processes NFj), the management module NRF sets the time window duration HBTₖ related to the functional process NFk to the possible value immediately higher than the time window duration HBTⱼ related to the other functional process NFj whose intermediate value Vⱼ is the closest to the intermediate value Vk (or, in other word, whose intermediate value Vⱼ is the greatest among the intermediate values of the other functional processes);
if the intermediate value Vₖ associated with the functional process NFk is between two intermediate values Vⱼ, Vₕ associated, respectively, with two other functional processes NFj, NFh, the management module NRF sets the time window duration HBTₖ related to the functional process NFk to the longest duration among the two time window durations HBTⱼ, HBTₕ related to these two other functional processes NFj, NFh, respectively;
if the intermediate value Vₖ associated with the functional process NFk is equal to another intermediate value Vⱼ, the management module NRF sets the time window duration HBTk related to the functional process NFk to the time window duration HBTj related to the functional process NFj associated with this other intermediate value Vⱼ.

The above-mentioned possible values can be predefined, for example in a set of discrete values. By way of illustration, the set of possible values can be defined by all the values from 5 s to 100 s, by steps of 5 s, or, as an alternative, by all the values from 1 s to 100 s, by steps of 1 s.

FIG. 4 is a flowchart showing another conceivable method for determining a time window duration HBTₖ related to a functional process NFk.

As indicated as regards the method of FIG. 3, this method can be implemented during step E8 described hereinabove or during step E24 described hereinabove.

This embodiment uses a table T stored in the memory MEM of the management module NRF and indicating, for each possible time window duration, the number of functional processes NFⱼ to which this time window value has been (previously) assigned.

The table T has hence a length N (in number of inputs in table) equal to the number of possible values for the time window duration.

This table T is filled in as the determinations of the different time window durations HBTⱼ related to the different functional processes Nfj are made.

The table T thus indicates the estimated number of heartbeat messages planned to be received at every time instant by the management module NRF (a time instant here corresponding to an input of the table T, two time instants corresponding to neighbor inputs in the table T, separated for example by 1 s).

As will be understood from the following, the present embodiment aims to distribute the heartbeat messages (expected from the different functional processes) over time in order to avoid overloading the management module NRF.

For that purpose, a predetermined value M (chosen as a function of the system characteristics) is used, which represents the maximum number of heartbeat messages that the management module NRF can process at a given time instant.

The method of FIG. 4 starts with a step E50 of initializing a current duration value d by an initial duration value d₀.

In practice, the initial duration value d₀ can be a predefined value (equal for example to the median of all the N possible values for the time window duration).

According to another exemplary embodiment, the initial duration value d₀ can be determined at each implementation of the method of FIG. 4, for example as a function of data related to the functional process NFk concerned and/or data related to other functional processes NFj. The initial duration value do can be determined by means of a method in accordance with that described hereinabove with reference to FIG. 3 (the time window duration obtained by this method being here used as the initial duration value d₀, and not directly as the time window duration for the functional process NFk).

The method of FIG. 4 continues with step E52 in which the management module NRF determines if the input associated with the current duration value d in the table T contains a value (strictly) lower than the maximum value M, i.e. if the maximum load M is not reached at the time instant defined by the current duration value d.

In other words, the management module NFR determines at step E52 if T[d]<M.

In case of positive determination (arrow P) at step E52, the maximum load M is not reached for the current duration value d and the method continues with step E72 in order to use this current duration value d as the time window duration HBTₖ for the functional process NFk, as described hereinafter.

In case of negative determination (arrow N) at step E52, the maximum load M is already reached for the current duration value d and the method then continues with step E54 that will now be described.

At step E54, the management module NRF increments (here by 1 s) the current duration value d.

The management module NRF then determines if the current duration value d still corresponds to an input of the table T, i.e. if d≤N.

In case of positive determination (arrow P) at step E56, the method loops to step E52 to determine if the input associated with the new current duration value d in the table T contains a value (strictly) lower than the maximum value V.

In case of negative determination (arrow N) at step E56, this means that all the table T inputs of index between d₀ and N have a value equal to M (indicating that the maximum load is estimated as being reached for all the time instants corresponding to these inputs). The method continues in this case with step E58 that will now be described.

At step E58, the management module NRF resets the current duration value d, this time with the value immediately below the initial duration value d₀, i.e. with the value (d₀−1).

The management module NRF then determines at step E60 if the input associated with the current duration value d in the table T contains a value (strictly) lower than the maximum value M, i.e. if the maximum load M is not reached at the time instant defined by the current duration value d. (It is therefore a test identical to that of step E52, the current duration value d being however different from those used during the different executions of step E52.)

In other words, the management module NFR determines at step E60 if T[d]<M. In case of positive determination (arrow P) at step E60, the maximum load M is not reached for the current duration value d and the method continues with step E72 in order to use this current duration value d as the time window duration HBTₖ for the functional process NFk, as described hereinafter.

In case of negative determination (arrow N) at step E60, the maximum load M is already reached for the current duration value d and the method then continues with step E66 that will now be described.

At step E66, the management module NRF decrements (here by 1 s) the current duration value d.

The management module NRF then determines (step E68) if the current duration value d still corresponds to an input of the table T, i.e. if d is strictly positive (d>0).

In case of positive determination (arrow P) at step E68, the method loops to step E60 to determine if the input associated with the new current duration value d in the table T contains a value (strictly) lower than the maximum value V.

In case of negative determination (arrow N) at step E68, this means that the maximum load is reached for all the time instants corresponding to the table T inputs. The method of FIG. 3 continues in this case at step E70.

During this step E70, the management module NRF can for example set the time window duration HBTₖ to the initial duration value d₀. As an alternative, the management module NRF could send to the functional process NFk (at step E10 or E26 described hereinabove) a value external to the possible value range for the time window duration.

When an execution of step E52 or E60 has identified a current duration value d for which the table contains a value (strictly) lower than the maximum value M (i.e. T[d]<M), the method of FIG. 4 continues as already indicated at step E72.

During this step E72, the management module NRF sets the time window duration HBTₖ to the so-identified current duration value d:

HBTₖ=d.

The management module NRF moreover increments, at step E72, the value T[d] of the input corresponding to the current duration value d. Indeed, the management module NRF then expects to receive the heartbeat message from the functional process NFk towards the end of the time window of duration HBTₖ (in addition to the other heartbeat messages expected at this time instant).

Moreover, independently of the just described process, the management module NRF shifts the table T by one input at every time instant (in this case, every second), in order to take account of the passage of time. Thus, for example, at every time instant, the first input T[1] of the table T contains the number of functional processes NFⱼ for which the time window assigned by the management unit NRF expires at the following time instant.

1. A management module for managing at least one functional process of a computer network, the management module being configured to check an arrival of at least one heartbeat message from the at least one functional process in a time window of a duration stored by the management module,
wherein the management module is configured to determine said duration.

2. The management module according to claim 1, wherein the management module is configured to determine said duration upon receipt of a preceding heartbeat message from the at least one functional process.

3. The management module according to claim 1, wherein the management module is configured to determine said duration upon each receipt of the at least one heartbeat message from the at least one functional process.

4. The management module according to claim 1, wherein the management module is configured to determine said duration upon receipt of a registration request from the at least one functional process.

5. The management module according to claim 1, wherein the management module is configured to send the determined duration to the at least one functional process.

6. The management module according to claim 1, wherein the management module is configured to determine said duration as a function of data related to the at least one functional process.

7. The management module according to claim 1, wherein the management module is configured to determine said duration as a function of data related to another functional process distinct from the at least one functional process.

8. The management module according to claim 1, wherein the management module is configured to determine said duration as a function of at least one estimated time of receipt of another heartbeat message from another functional process distinct from the functional process.

9. The management module according to claim 1, wherein the management module is configured to modify a status of the at least one functional process stored in the management module, when the heartbeat message is not received within said time window.

10. The management module according to claim 1, wherein the heartbeat message is a request to update a profile of the at least one functional process stored in the management module.

11. A computer network comprising:
the management module according to claim 1; and
a processor configured to implement the at least one functional process.

12. A method for managing at least one functional process of a computer network, the method comprising:
determining a time window duration; and
checking an arrival of a heartbeat message from the at least one functional process in a time window having the determined time window duration.

13. The management method according to claim 12, wherein the time window duration is determined as a function of data related to another functional process distinct from the at least one functional process.

14. The management method according to claim 12, wherein the determining is implemented upon receipt of a preceding heartbeat message from the at least one functional process.

15. A non-transitory computer-readable medium on which is stored a computer program comprising instructions executable by a processor and configured to implement the method according to claim 12 when the instructions are executed by the processor.

16. The management module according to claim 2, wherein the management module is configured to determine said duration upon each receipt of the at least one heartbeat message from the at least one functional process.

17. The management module according to claim 2, wherein the management module is configured to determine said duration upon receipt of a registration request from the at least one functional process.

18. The management module according to claim 3, wherein the management module is configured to determine said duration upon receipt of a registration request from the at least one functional process.
